(19) United States
(12) Patent Application Publication
(10) Pub. No.: US 2007/0280336 A1
(43) Pub. Date: Dec. 6, 2007

(54) Constrained Optimization Based Mimo Lmmse-Sic Receiver for Cdma Downlink

(75) Inventors: Jianzhong Zhang, Irving, TX (US); Balaji Raghothaman, San Diego, CA (US); Giridhar Mandyam, San Diego, CA (US)

Correspondence Address: HARRINGTON & SMITH, PC, 4 RESEARCH DRIVE, SHELTON, CT, 06484-6212, US

(73) Assignee: NOKIA CORPORATION, ESPOO, FINLAND (FI)

(21) Appl. No.: 10/590,671

(22) PCT Filed: Feb. 23, 2005
(86) PCT No.: PCT/US05/06132

§ 371 Date: Jun. 1, 2007

Related U.S. Application Data
(60) Provisional application No. 60/548,477, filed on Feb. 27, 2004.

(51) Int. Cl. H04Q 7/00

(52) U.S. Cl. 375/148; 375/229; 375/260; 375/E01.001

(57) ABSTRACT

A system according to embodiments of this invention provide a multiple transmit antenna (117-1 . . . M), multiple receive antenna (121-1 . . . N) (MIMO) receiver (125) design for the communication downlinks such as those used in CDMA technology. Two algorithms referred to as the MIMO LMMSE-FFT and MIMO LMMSE-SIC (Successive Interference Cancellation) algorithms, are described in detail. In embodiments of the invention, the interference cancellation step is achieved without the impractical assumption of the knowledge of all the active Walsh codes in the systems, unlike many other interference cancellation based algorithms found in the literature.

### FIELD OF THE INVENTION

This invention pertains in general to communication systems. More particularly, embodiments of the invention pertain to transmit diversity and Multiple-In, Multiple-Out (MIMO) transmission and receiving methods for multiple antenna technology of Code Division Multiple Access (CDMA) type systems.

### BACKGROUND

Inter-chip interference (ICI) is a result of the multipath frequency selective channel in the CDMA downlink. The presence of ICI destroys the orthogonality of the Walsh spreading codes at mobile terminals. The challenge to the receiver design is even greater for a MIMO system in the CDMA downlink. The receiver has to combat both the ICI and the co-channel interference (CCI) to achieve reliable communication. Therefore, interference cancellation at the mobile stations is an effective means of improving the receiver performance and link capacity.

For a Single-In, Single-Out (SISO) or Single-In, Multiple-Out (SIMO) system, there are two types of linear equalizers: non-adaptive and adaptive equalizers. A non-adaptive equalizer usually requires matrix inversion and is therefore computationally expensive ( I. Ghauri and D. T. M. Slock, “Linear Receivers for the DS-CDMA Downlink Exploiting Orthogonality of Spreading Sequences” in Proc. of 32^{nd} Asilomar Conference, pages 650-654, 1998; A. Klein, “Data Detection Algorithms Specially Designed for the Downlink of CDMA Mobile Radio Systems” In Proc. of VTC 97, pages 203-207, Phoenix Ariz., 1997; T. P. Krauss, W. J. Hillery and M. D. Zaltowski, “MMSE Equalization for forward link in 3G CDMA: Symbol Level Versus Chip-level” In Proc. of 10^{th} IEEE Workshop on Statistical Signal and Array Processing, pages 18-22, 2000; S. Werner and J. Lilleberg, “Downlink Channel Decorrelation in CDMA Systems With Long Codes”, In Proc. of 49^{th} VTC, pages 1614-1617, 1999 ), especially when the coherence time of the channel is short and the equalizer requires frequent update. An adaptive equalizer is less computationally involved since it does not require direct matrix inversion, but it is not as robust as the non-adaptive equalizers since its performance is sensitive to the choice of parameters such as step size, initialization, etc (M. J. Heikkila, “A Novel Blind Adaptive Algorithm for Channel Equalization in WCDMA Downlink”, In Proc. of 12^{th} IEEE Symposium or PIMRC, pages A41-A45); ( W. J. Heikkil/a, P, Kowu/aises, and J. Lilleberg, “Interference Suppression in CDMA Downlink Through Adaptive Channel Equalization” In Proc. of VTC 99-Fall, pages 978-982, Amsterdam, The Netherlands, 1999); (Mika Ventola, “Performance Analysis of Dual ANtenna Reception in WCDMA Downlink: issue 1,0” NMP/RTA, March 2002). Solutions to these difficulties have been proposed (J. Zhang, T. Bhatt, and G. Mandyam, “Efficient FFT Based Linear Equalization for CDMA Downlink”, in Proceedings of Asilomar Conference, November 2003.)

An FFT-based linear equalization algorithm was proposed for SISO/SIMO systems that provides a good tradeoff between complexity and performance. The algorithm approximates the non-adaptive LMMSE algorithm by exploiting the banded Toeplitz structure of the correlation matrix of the received signal vector. Another attractive alternative is the Kalman filtering approach proposed in H. Nguyen, K. Zhang, and B. Raghothaman, “Equalization of CDMA downlink channel via Kalman filtering.” In Proceedings of Asilomar Conference, November 2003, where an interesting state-space model is established to facilitate the application of the recursive Kalman filter. This approach outperforms the LMMSE approach at higher complexity.

For a MIMO system, it has also been shown that both the conventional LMMSE algorithm and the Kalman filter algorithm can be extended to the MIMO situation. In these MIMO solutions, both the ICI and CCI are suppressed in the linear equalization phase of the receiver. However, these solutions require complicated signal processing whose computational complexities may be beyond practical limits of the current hardware implementation. On the other hand, attempts to combine the non-linear decision feedback interference cancellation with the LMMSE equalization are also found in the literature, for example, L. Mailander. and J. G. Proakis, “Linear Aided Decision Feedback Equalization of CDMA Downlink” in Proceedings of Asilomar Conference, November 2003. However, these algorithms perform the decision feedback directly at the received signal, and thus require the impractical assumption that all the active Walsh codes are known at the mobile receiver in order to reconstruct the transmitted chip sequences.

### SUMMARY OF THE PREFERRED EMBODIMENTS

In accordance with an embodiment of the present invention, a receiver having a first and a second antenna for receiving at least two spread spectrum symbols from a transmitter having at least first and second transmit antennas, comprises a first data path for generating a first estimated symbol â₁(f) from the first antenna, a second data path for generating an estimated symbol sum âₛ(f) from the first and second antennas, and an interference cancellation module having inputs coupled to the first and second data paths, the interference cancellation module for canceling co-channel interference (CCI) between the estimated symbol sum and the first estimated symbol to generate a second estimated symbol.

In accordance with an alternative embodiment of the present invention, a wireless receiver having at least two receive antennas for receiving a CDMA transmission from a transmitter having at least two transmit antennas, comprises a channel estimator having an input coupled to the at least two receive antennas, a first output, and a second output, a first chip equalizer having a first input connected to the at least two receive antennas and a second input of the channel estimator for l suppressing inter-chip interference (ICI) and co-channel interference (CCI) from at least one antenna other than a first one of the at least two antennas and for generating an estimated chip sequence from the first antenna, the first chip equalizer having an output coupled to a first processing module for descrambling and despreading the output of the first chip equalizer and generating a first estimated symbol â₁(f), a second chip equalizer having a first input coupled to the at least two receive antennas and a second input comprising the second output of the channel estimator for generating an estimated chip sequence sum from the at least two receive antennas and a residual CCI, the second chip equalizer having an output coupled to a second processing module for descrambling and despreading the output of the second chip equalizer and generating an estimated symbol sum âₛ(f), an interference cancellation module, having the first estimated symbol â₁(f), the estimated symbol sum âₛ(f) and an output of the second equalizer as inputs, for canceling CCI and generating at least one estimated symbol, and a decoder for decoding the at least one estimated symbols.

In accordance with an alternative embodiment of the present invention, a method of receiving a CDMA transmission in a wireless receiver having at least two receive antennas, the transmission comprising at least two symbols from a transmitter having at least first and second transmit antennas, comprises the steps of generating a first estimated symbol â₁(f) from the first antenna, generating an estimated symbol sum âₛ(f) from the first and second antennas, and determining a second estimated symbol by canceling interference between the estimated symbol sum and the first estimated symbol.

In accordance with an alternative embodiment of the present invention, a wireless receiver having a first and a second receive antennas for receiving a CDMA transmission comprising at least two symbols from a transmitter having at least first and second transmit antennas in which not all spreading codes are known, comprises means for receiving an input data on a first data path for generating a first estimated symbol â₁(f) from the first antenna, means for receiving the input data on a second data path for generating an estimated symbol sum âₛ(f) from the first and second antennas, means for utilizing the first estimated symbol â₁(f) and the estimated symbol sum âₛ(f) as a plurality of inputs to an interference cancellation module, for canceling CCI and generating at least one estimated symbol, and means for decoding the at least one estimated symbol.

In accordance with an alternative embodiment of the present invention, a program of machine-readable instructions, tangibly embodied on an information bearing medium and executable by a digital data processor, to perform actions directed toward transmission and receiving methods for multiple antenna technology, the actions comprises receiving as a first input a first estimated symbol â₁(f) derived from a first antenna, receiving as a second input an estimated symbol sum âₛ(f) derived from the first antenna and a second antenna, and calculating a second estimated symbol by canceling interference between the estimated symbol sum and the first estimated symbol.

In accordance with an alternative embodiment of the present invention, a method for receiving a CDMA transmission in a wireless receiver having at least two receive antennas, the transmission comprising at least two symbols from a transmitter having at least first and second transmit antennas, comprises the steps of step for generating a first estimated symbol â₁(f) from the first antenna, step for generating an estimated symbol sum âₛ(f) from the first and second antennas, and step for determining a second estimated symbol by canceling interference between the estimated symbol sum and the first estimated symbol.

### BRIEF DESCRIPTION OF THE DRAWINGS

These and other features, aspects, and advantages of embodiments of the present invention will become apparent with reference to the following description in conjunction with the accompanying drawings. It is to be understood, however, that the drawings are designed solely for the purposes of illustration and not as a definition of the limits of the invention.

FIG. 1 is illustrative of an embodiment of a MIMO-CDMA system of the present invention.

FIG. 2 is a diagram of the transmit signaling at antenna m of an embodiment of the present invention.

FIG. 3 is a high level block diagram of a typical prior art MIN4-LMMSE receiver.

FIG. 4 is a block diagram showing an embodiment of a LMMSE-SIC receiver according to the present invention.

FIG. 5 is a graphical illustration of a mixed traffic 1X EV-DV system.

FIG. 6 is an illustration of the conditional mean estimator.

FIG. 7 is a graph showing simulation results of an embodiment of the MIMO LMMSE-SIC algorithm of the present invention.

FIG. 8 is a graph showing simulation results for the MIMO LMMSE-SIC algorithm with 2 iterations.

### DETAILED DESCRIPTION

A system according to embodiments of this invention provides a multiple transmit antenna, multiple receive antenna (MIMO) receiver design for communication downlinks such as those used in CDMA technology. Two algorithms referred to as the MIMO LMMSE-FFT-and MIMO LMMSE-SIC (Successive Interference Cancellation) algorithms, are described in detail. In embodiments of the invention, the interference cancellation step is achieved without the impractical assumption of the knowledge of all the active Walsh codes in the system.

Embodiments of this invention provide a multiple transmit antenna, multiple receive antenna (MIMO) receiver design for communication downlinks such as those used in CDMA technology.

Multiple transmit, multiple receive antenna MIMO systems offer potential for realizing high spectral efficiency in a wireless communications system. Information theoretic studies establish that in an independent flat-fading channel environment, the capacity of such an MIMO system increases linearly with the number of antennas. A practical MIMO configuration, such as a Bell Labs Layered Space-Time (BLAST) system, may be deployed to realize this high spectral efficiency for a narrow-band TDMA system. A simpler form of BLAST, the vertical BLAST (V-BLAST) has been proposed to simplify the transceiver BLAST design. In V-BLAST, independent parallel data sequences are transmitted and a successive co-channel interference CCI cancellation/data detection algorithm is used for efficient multi-symbol detection.

In the downlink of a CDMA like system, most of the research has focused on the application of advanced signal processing techniques to offset the performance degradation due to the loss of Walsh code orthogonality caused by the frequency selective multipath channel. Channel equalization is a promising means of improving the receiver performance in a frequency selective CDMA downlink. Current research encompasses two approaches to linear equalization, namely non-adaptive linear equalization (e.g., T. P. Krauss, W. J. Hillery, and M. D. Zoltowski, “MMSE equalization for forward link in 3G CDMA: Symbol-level versus chip-level,” in Proc. of 10th IEEE workshop on Statistical Signal and Array Processing, pp. 18-22, 2000), and adaptive linear equalization (e.g., M. J. Heikkila, P. Komulainen, and J. Lilleberg, “Interference suppression in CDMA downlink through adaptive channel equalization,” in Proc. of VTC 99-Fall, (Amsterdam, The Netherlands), pp. 978-982, 1999, L. Mailaender, “Low-complexity implementation of CDMA downlink equalization,” in Proc. of 2001 IEE 3G Mobile Communication Technologies, pp. 396-400, 2001.)

Non-adaptive linear equalizers usually assume “piece-wise” stationarity of the channel, and design the equalizer according to some optimization criteria such as Linear Minimum Mean Square Error (LMMSE) or zero-forcing, which in general leads to solving a system of linear equations by matrix inversion. This can be computationally expensive, especially when the coherence time of the channel is short and the equalizers have to be updated frequently.

On the other hand, adaptive algorithms solve the similar LMMSE or zero-forcing optimization problems by means of stochastic gradient algorithms and avoid direct matrix inversion. Although computationally more manageable, the adaptive algorithms are less robust since their convergence behavior and performance depend on the choices of parameters such as step size.

To overcome these difficulties, in J. Zhang, T. Bhatt, and G. Mandyam, “Efficient linear equalization for high data rate downlink CDMA signaling,” in Proceedings of Asilomar Conference, November 2003, an FFT-based linear equalization algorithm was proposed that provides a good trade off between complexity and performance. The algorithm approximates the non-adaptive LMMSE algorithm by exploiting the banded Toeplitz structure of the correlation matrix of the received signal vector. Another attractive alternative is a Kalman filtering approach wherein an interesting two state-space model is established to facilitate the application of the recursive Kalman filter. This approach outperforms the LMMSE approach at a slightly higher complexity.

Applying the MIMO configuration to the CDMA downlink presents a significant challenge to the receiver design, as the receiver has to combat both the ICI and the CCI in order to achieve reliable communication. It has been shown in H. Nguyen, J. Zhang, and B. Raghotharman, “Equalization of CDMA downlink channel via Kalman filtering,” (Proceedings of Asilomar Conference, November 2003) that both the conventional LMMSE algorithm and the Kalman filter algorithm can be extended to the MIMO system.

In embodiments of the invention, a MIMO LMMSE-SIC algorithm is provided that uses successive interference cancellation to improve the performance of a conventional linear MIMO LMMSE equalizer. One non-limiting advantage of the use of the MIMO LMMSE-SIC algorithm in accordance with embodiments of this invention is that interference cancellation is achieved without the impractical assumption of the knowledge of all the active Walsh codes in the systems, unlike many other interference cancellation based algorithms found in the literature. The MIMO LMMSE-SIC algorithm detailed herein also incorporates the so-called conditional mean estimator to provide soft decisions in the decision feedback process. Simulation results presented herein suggest that the soft decisions alleviate the error propagation problem in the SIC associated with hard decision feedbacks.

MIMO Signal Model for CDMA Downlink

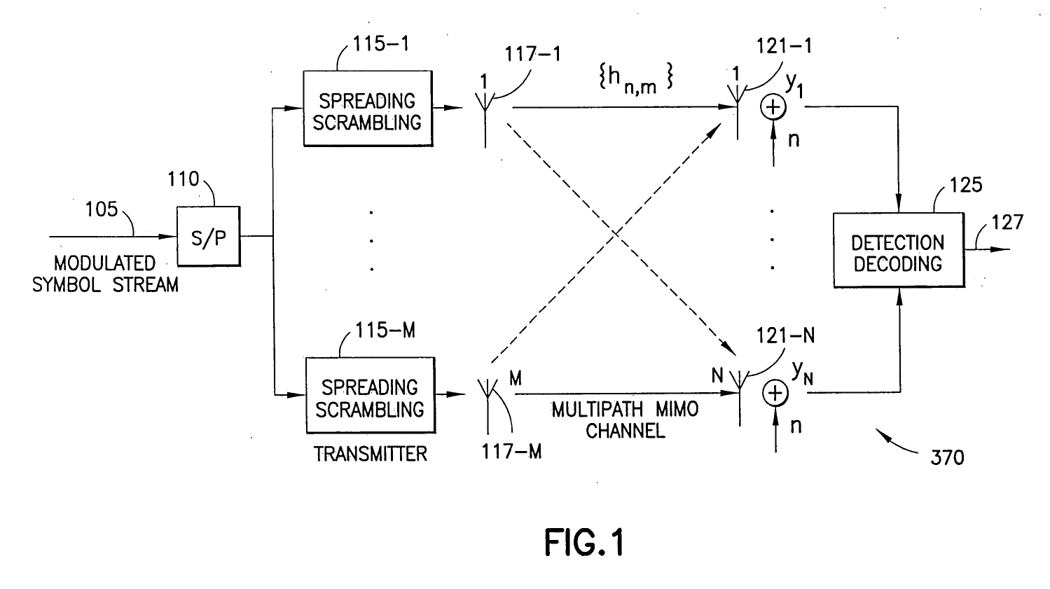

Consider an M transmit antenna, N receive antenna MIMO CDMA system as illustrated in FIG. 1. Serial to parallel split transmit multiplexing in unit 110 is assumed in order to make the receiver solutions general enough for all possible MIMO transmit multiplexing methods. The modulated symbol stream on line 105 is split at the transmitter into M sub-streams before being transmitted across the M transmit antennas.

Blocks 115-1-115-M represent the process of spreading the data according to a spreading code, such as a Walsh code, and scrambling the data with a known long PN code and allocating the data to the several transmitter antennas 117-1 to 117-M. The signals pass through a channel or channels to receiving antennas 121-1 to 121-N where they are received as signals y₁ to y_{N} and then detected in a detector/decoder 125 and output on line 127.

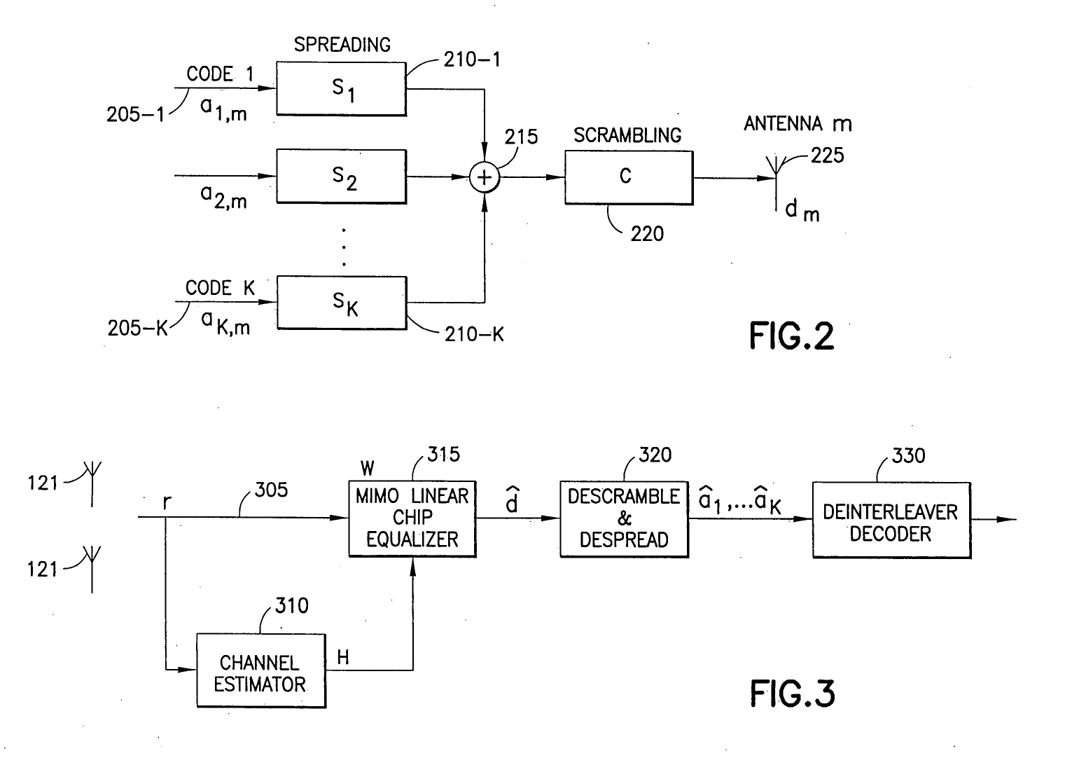

As shown in FIG. 2, the signal model at the mₜₕ transmit antenna is given as follows, assuming K active Walsh codes in the system:

$${d}_{m} ( i ) = c ( i ) {\sum }_{k = 1}^{K} {\sum }_{m} {α}_{k} {α}_{k , m} ( j ) {s}_{k} ( i - jG ) \qquad ( 1 )$$

where i, j, m and k are chip, symbol, transmit antenna and spreading code indices respectively. The base station scrambling code is denoted by c(i). Meanwhile, aₖ stands for the power assigned to spreading code k (same for all antennas), a_{k,m} is the information symbol sequence for spreading code k at antenna m and sₖ is the kₜₕ spreading code. Note that in this model it is implicitly assumed that the same set of Walsh codes are used across all the transmit antennas. Signals for the mth antenna having k spreading codes arrive on lines 205-1 to 205-k on the left of FIG. 2 and are spread with the k codes in units 210-1 to 210-K, are summed in unit 215 and are processed and scrambled in unit 220, then transmitted along the mth antenna 225. The transmitted signals propagate through the MIMO multipath fading channel denoted by H₀, . . . H_{L}, where each matrix is of dimension NΔ×M, where denotes the number of samples per chip.

The N signals are received on N antennas 121-1 to 121-N as signals y₁, . . . y_{N}, producing y1 . . . yN RF signals that are detected and decoded in unit 125 and passed out on line 127 for further processing.

The signal model at the receive antennas is thus given by the following equation, after stacking up the received samples across all the receive antennas 121-1 to 121-N for the ith chip interval.

$${y}_{i} = {\sum }_{l = 0}^{L} {H}_{l} {d}_{i - 1} + {n}_{i} . \qquad ( 2 )$$

Note that yᵢ=[y_{i,1}^{T}, . . . , y_{i,N}^{T}]^{T} is of length N Δ, and each small vector y_{i,n} includes all the temporal samples within the ith chip interval.
Meanwhile, L is the channel memory length,
dᵢ₋ₗ=[d₁(i−l), . . . , d_{M}(i−l)]^{T} is the transmitted chip vector at time i−1 and nᵢ s the NΔ×1 dimensional white Gaussian noise vector with nᵢ˜N(0,σ²I). Note that σ² denotes noise variance and I is the identity matrix. Furthermore, in order to facilitate the discussion on the LMMSE receiver, a block of 2F+1 received vectors are stacked up:
y_{i+F:i-F}=Hd_{i+F:i-F-L}+n_{i+F:i-F} (3)
where 2F+1 is the length of the LMMSE equalizing filter and
y_{i+F:i-F}=[y_{i+F}^{T}, . . . ,y_{i-F}^{T}]^{T}, ((2F+1)NΔ×1)
n_{i+F:i-F}=[n_{i+F}^{T}, . . . ,n_{i-F}^{T}]^{T}, ((2F+1)NΔ×1)
d_{i+F:i-F-L}=[d_{i+F}^{T}, . . . ,d_{i-F}^{T}]^{T}, ((2F+L1)M×1)

$$H = [ \begin{matrix}{H}_{0} & ⋯ & {H}_{L} & & \\ & ⋰ & & ⋰ & \\ & & {H}_{0} & ⋯ & {H}_{L}\end{matrix} ] , ( ( 2 F + 1 ) N Δ ⨯ ( 2 F + L + 1 ) M )$$

where the dimensions of the matrices are given next to them. Note that to keep the notation more intuitive, the subscripts are kept at a block level. For instance, y_{i+F:i-F} is the vector that contains blocks y_{i+F}, . . . , y_{i-F} where each block is a vector of size NΔ×1.
MIMO LMMSE Chip-Level Equalization

The block diagram of the MIMO receiver with chip-level equalizer algorithm is shown in FIG. 3. It is a straightforward extension of the LMMSE chip equalization initially designed for a SISO system.

An input signal received at the various antennas 121 enters on line 305 and passes to channel estimator 310 and chip equalizer 315. The output of the estimator 310 is input to the equalizer so that it may equalize the channels and resolve the various received signals y₁, Y_{N}. After the chip-level equalizer, the orthogonality of the Walsh code is partially re-installed and all the desired symbols from each transmit antenna are detected with a simple code correlator 320 which correlates to the desired spreading code. The descrambling process is also included in the code correlator block 320, typically prior to de-spreading. Unit 330 performs deinterleaving and decoding.

Defining an error vector of Z=dᵢ−W^{H}y_{i+FLi-F} and an error covariance matrix R_{zz}=E[zz^{H}], the MIMO LMMSE chip-level equalizer W is the solution of the following problem:

$${W}^{opt} = arg {min}_{W} Trace ( {R}_{zz} ) = arg {min}_{W} E {‖ {d}_{i} - {W}^{H} {y}_{i + F : i - F} ‖}^{2} , \qquad ( 4 )$$

whose optimal solution is given by:
W^{opt}=σ_{d}²R⁻¹H_{i:i} (5)
Where R=E[y_{i+F:i-F}y_{i+F:i-F}^{H}] is the correlation matrix of the received signal, and σ_{d}² is the transmitted chip power. Meanwhile, although H is fixed for a given channel realization and is not a function of symbol index i, here there is used the notation H_{i+F:i+1}, H_{i:i} and H_{i-1:i-F}-L to represent the sub-matrices of the overall channel matrix H that are associated with d_{i+F:i+1}, dᵢ and d_{i-1:i-F-L} in the expansion of the matrix-vector product:

$$\begin{matrix}{Hd}_{i + F : i - F} {=}^{Δ} [ {H}_{i + F : i + 1} {H}_{i : i} {H}_{i - 1 : i - F - L} ] [ \begin{matrix}{d}_{i + F : i + 1} \\ {d}_{i} \\ {d}_{i - 1 : i - F - L}\end{matrix} ] \\ = {H}_{i + F : i + 1} {d}_{i + F : i + 1} + {H}_{i : i} {d}_{i} + {H}_{i - 1 : i - F - L} {d}_{i - 1 : i - F - L} .\end{matrix} \qquad ( 6 )$$

Constrained Optimization Based Non-linear LMMSE-SIC

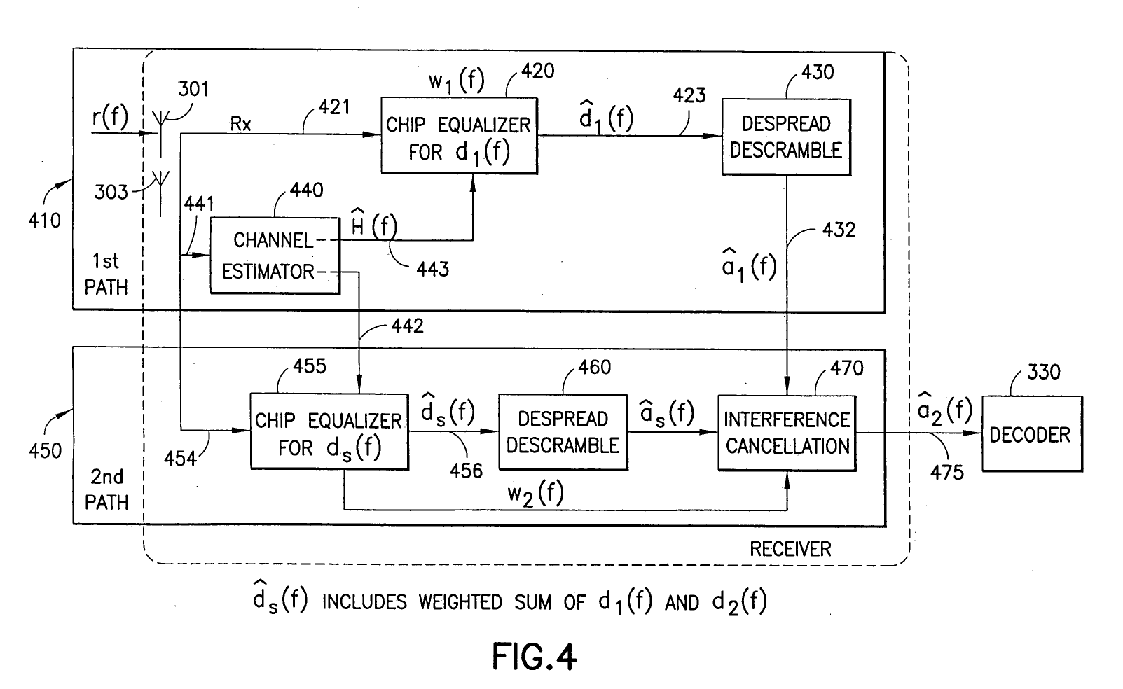

Both MIMO LMMSE and MIMO LMMSE-FFT belong to the category of linear equalization methods. In this section, there is introduced the non-linear decision feedback to the MIMO LMMSE equalizer to improve the overall receiver performance. The resulting LMMSE-SIC (LMMSE- Successive Interference Cancellation) receiver is illustrated in FIG. 4 for a MIMO system having two transmit and N receive antennas.

There are two symbol-detection paths 410, 450 in FIG. 4 where the first/second path aims at detecting symbols transmitted on the respective first/second transmit antenna. The first path 410 is similar in certain respects to that of a conventional MIMO LMMSE receiver (eg., FIG. 3), where the chip-equalizer 420, having input 421, is connected to antennas 301, 303 and has an output 423 connected to unit 430. Using frequency domain representation for ease of exposition, ω₁(f) is designed such that both the ICI and the spatial CCI from the other transmit antenna is suppressed in the estimated chip sequence \hat{d}₁(f). This beneficially facilitates the de-spreading and symbol detection in unit 430 to generate a first estimated symbol â₁(f) by restoring the orthogonality between the Walsh codes. Note that only the symbols carried on the desired users' Walsh codes are detected. As shown in FIG. 4, these detected symbols from the first path are directly fed-back along line 432 and used in the symbol detection of the second path.

In the preferred embodiment of the receiver, the channel estimator 440 has an input 441 connected to the antennas 301, 303, a first output 443 connected to equalizer 420 and a second output 442 connected to equalizer 455.

The second path 450 of the LMMSE-SIC receiver deviates from that of a conventional MIMO LMMSE receiver at least for the reason that the chip equalizer 455 [ω₂(f)], having input 454 and output 456, does not attempt to directly generate the chip sequence from the second transmit antenna. Instead, it generates a weighted sum of the chip sequences \hat{d}ₛ(f) on output 456 from both transmit antennas, while suppressing all the ICIs. Mathematically,
\hat{d}ₛ(f)=d₂(f)+b_{2,1}d₁(f)+n₂(f). (7)

This filter 455 provides complete temporal ICI suppression while keeping a “controlled” residue CCI whose strength is denoted by a design parameter b_{2,1}. Furthermore, this design parameter is jointly optimized with the filter coefficients to achieve the best performance. The detailed derivation of this joint optimization is provided in the next section. Note that b_{2,1} is a post filtering parameter that is obtained by optimizing as in equation (10) below.

Since the same set of Walsh codes are used in both transmit antennas, it follows that a simple descrambling/despreading process gives us the symbol sum estimate âₛ(f) output from despreader 460 (for a particular Walsh code) that also includes a controlled residue CCI:
âₛ(f)=a₂(f)+b_{2,1}a₁(f)+n′₂(f). (8)
where the noise variance σ_{n′2}²=1/Gσₙ₂² is the spreading length. Those skilled in the art will appreciate that, assuming correct symbol estimations â₁(f ) from the first path, the symbol estimate for the second transmit antenna is given by:
â₂(f)=âₛ(f)−b_{2,1}â₁(f). (9)

Unit 470 accepts as input the estimated sum from unit 460 and the chip equalizer function ω₂ (f) (which helps to generate the feedback coefficient b_{2,1} in box 470), performs the calculation and sends the values of â₁(f ) and â₂(f) to decoder 330. With the help of a standard soft demodulator (represented schematically by box 470), the soft channel-coded bits can be easily extracted from the symbol estimates â₁(f ),â₂(f) before being sent to the decoder along line 475 to complete the receiver processing. As shown below, significant performance gain can be achieved with a LMMSE-SIC receiver, compared to a conventional LMMSE receiver.

Furthermore, the LMMSE-SIC algorithm achieves the performance gains without having to make the impractical assumption of a priori knowledge at the receiver of all of the active Walsh codes. This important advantage makes the presently preferred LMMSE-SIC especially attractive for a fixed voice-data system such as 1X EV-DV or HSDPA and the like, where the desired user usually accounts for only, typically, ten to fifty percent of the overall transmit power in a cell. Such a mixed voice-data 1X EV-DV system is illustrated in FIG. 5, where the data user of interest and another data user each consumes about 20 percent of the transmit power, while the remainder of the transmit power is assigned to voice users in the cell, in addition to some housekeeping overheads such as pilot, synchronization, etc. Also note that in this example system, data users have a spreading length of 32 while the voice users have a spreading length of 64.

Joint Equalizer/Feedback Weights Optimization

As noted in the two transmit MIMO example above, the filter coefficients and the feedback weight b₁₂ require joint optimization. In this section, a joint optimization problem for a general M transmitter MIMO system is formulated and it is shown that the problem can be converted into a series of M minimum variance distortionless responses (MVDR) problems that are easily solved with a Lagrange Multiplier algorithm.

Returning to the matrix-vector notation used in equations (3-6), the joint equalizer/feedback weights optimization for a M transmit, N receive MIMO system can be formulated as the following LMMSE problem with a lower-triangular structural constraint on the feedback weights:

$${W}^{opt} , {B}^{opt} = arg {min}_{W , B} Trace ( {R}_{zz} ) = arg {min}_{W , B} E {‖ {B}^{H} {d}_{i} - {W}^{H} {y}_{i + F : i - F} ‖}^{2} , \\ s . t . B = [ \begin{matrix}1 & & 0 \\ ⋮ & ⋰ & \\ {b}_{M , 1} & ⋯ & 1\end{matrix} ] . \qquad ( 10 )$$

Note that in this case the error vector is defined as
z=B^{H}dᵢ−W^{H}y_{i+F:i-F}

The values of the coefficients in the set of chip equalizers (W) and the feedback weights (B) used to multiply an estimated kth symbol (d₁) fed into the calculation of the i^{th} estimated symbol are found by minimizing the trace of the error correlation matrix, subject to the constraint on the structure of the matrix B.

A direct application of Lagrange multipliers to equation (10) proves to be difficult. To exploit the structure of the problem, the structural constraint in (10) is reorganized into two constraints that are more compact:
b_{m,m}=1,m=1, . . . ,M and
Zb=0 (11)
where b_{m,m} [symbol] (B)_{m,m}, and
bΔ=vec(B^{H})=[b₁^{T}, . . . b_{M}^{T}]^{T} (12)
in which bₘ is the mₜₕ column of B. Note that vec(B) denoted a column-wise stack-up of the matrix(B). Furthermore, Z is defined as

$$Z {=}^{Δ} [ \begin{matrix}{Z}_{1} & & \\ & ⋰ & \\ & & {Z}_{M}\end{matrix} ] \qquad ( 13 )$$

where each sub-matrix Zₘ is an M×M diagonal matrix denoting the index of the null elements in bᵢ, that is, (Zₘ)_{k,k}=1 if the kth element in bₘ is constrained to be zero, and (Zₘ)_{k,k}=0 if it is not. Similarly, there is defined another diagonal matrix N=diag N₁ . . . N_{M} that denotes the index to the non-zero elements in b. It is evident that Zₘ+Nₘ=I by definition, where I is the identity matrix. With these definitions, the MMSE problem is set up to provide optimal W and B with a generalized feedback structure:

$${W}^{opt} , {B}^{opt} = arg {min}_{W , B} E {‖ {B}^{H} {d}_{i} - {W}^{H} {y}_{i + F : i - F} ‖}^{2} , s . t . \\ {b}_{m , m} = 1 , m = 1 , … , M and \\ Zb = 0. \qquad ( 14 )$$

To proceed, note that the expectation in equation (14), referred to as the cost function J can be written as:

$$\begin{matrix}J = E {‖ {W}^{H} {y}_{i + F : i - F} - {B}^{H} {d}_{i} ‖}^{2} \\ = {\sum }_{m = 1}^{M} {‖ {w}_{m}^{H} {H}_{i : i} - {b}_{m}^{H} ‖}^{2} + {\sum }_{m = 1}^{M} {w}_{m}^{H} {Vw}_{m}\end{matrix} \qquad ( 15 )$$

where V=^{Δ}σ_{d}² H̅_{i:i} H̅_{i:i}^{H}+σ²I, Wₘ is the mth column of W. Note that H̅_{i:i} is a submatrix of H that is obtained by excluding H_{i:i} in the matrix H. Meanwhile, in the derivation, yi+F: i-F has been substituted from equation (3). The identity I=Zₘ+Nₘ is utilized to break up H_{i:i} and bₘ^{H} as:
H_{i:i}=H_{i:i}Nₘ+H_{i:i}Zₘ,
bₘ^{H}=bₘ^{H}Nₘ+bₘ^{H}Zₘ.
Substituting (16) into (15) yields:

$$J = {\sum }_{m = 1}^{M} {‖ {w}_{m}^{H} {H}_{i : i} {N}_{m} - {b}_{m}^{H} {N}_{m} ‖}^{2} + {\sum }_{m = 1}^{M} {w}_{m}^{H} {V}_{m} {w}_{m} \qquad ( 17 )$$

where Vₘ^{Δ}=H_{i:i}ZₘH_{i:i}^{H}+V has been defined. Since c contains the controllable non-zero elements in bₘ^{H}, the first term in J is minimized by setting
bₘ^{H}Nₘ=H_{i:i}Nₘ. (18)

Meanwhile, it is observed that the second sum in J is optimized by individually minimizing

$${w}_{m}^{opt} = \text{arg} {min}_{{w}_{m}} {w}_{m}^{H} {V}_{m} {w}_{m} , \\ s . t . {w}_{m}^{H} {h}_{m} = 1 ; for m = 1 , … , M \qquad ( 19 )$$

Note that hₘ is the mth column of the matrix H_{i:i}, and the constraint wₘ^{H}hₘ=1 follows from (18) and the original constraint b_{m,m=}1. The complex optimization problem (10) is thus decoupled into a series of simple MVDR optimization problems (19) to get the filter coefficients wₘ. The non-zero elements in the feedback weight vectors bₘ are then obtained from (18). A straightforward application of the Lagrange Multiplier method to (19) leads to the final solution to the joint optimization problem:

$${w}_{m}^{opt} = \frac{{V}_{m}^{- 1} {h}_{m}}{{h}_{m}^{H} {V}_{m}^{- 1} {h}_{m}} \\ {( {b}_{m}^{opt} )}^{H} {𝒩}_{m} = {( {w}_{m}^{H} )}^{opt} {H}_{i \text{:} i} {𝒩}_{m} , \qquad ( 20 )$$

and the elements of the resulting error correlation matrix is given by
(R_{zz})_{m,n}=(wₘ^{opt})^{H}(V+H_{i:i}ZₘZₙH_{i:i}^{H})wₙ^{opt}. (21)
Soft Decision Feedback

In the two transmit, two receive example illustrated in FIG. 4, the estimated symbol from the first path â₁(f) is used in (9) to obtain the symbol estimates for the second path. If these symbol estimates â₁(f) from first path are generated by hard-decisions, then the performance degradation for the second path can be severe due to error propagations.

The error propagation problem can be alleviated by using soft decision feedback. There are many types of soft estimators in the literature. The so-called conditional mean based estimator is both analytically pleasing and easy to implement. This conditional mean estimator (also known as MMSE estimator) is also used in similar decision feedback algorithms. Consider the general signal model for an arbitrary symbol at the output of the de-spreader:
r_{k,n}(j)=ca_{k,m}(j)+n, (22)
where c is a multiplicative factor and k,m,j are Walsh code, transmit antenna and symbol indices, respectively. Also note n is assumed to be Gaussian: n˜N(0,σₙ²) and both c and σₙ² are functions of the spreading gain G, transmit power aₖ, noise level σ², channel H and the filter Wopt. Once c and σₙ² are obtained, the conditional mean estimate of a_{k,m(j)} is given by
â_{k,m}(j)=E[a_{k,m}(j)|r_{k,m}(j)], (23)
which has a closed-form solution if one invokes the Gaussian assumption. For example, when the symbols of interest are QPSK modulated with unit energy, the solution reduces to a simple hyperbolic tangent function:

$${\hat{a}}_{k , m} ( j ) = \frac{1}{\sqrt{2}} tanh ( \frac{\text{Re} ( \sqrt{2} {c}^{*} {r}_{k , m} ( j ) )}{{σ}_{n}^{2}} ) + j \frac{1}{\sqrt{2}} tanh ( \frac{\text{Im} ( \sqrt{2} {c}^{*} {r}_{k , m} ( j ) )}{{σ}_{n}^{2}} ) . \qquad ( 24 )$$

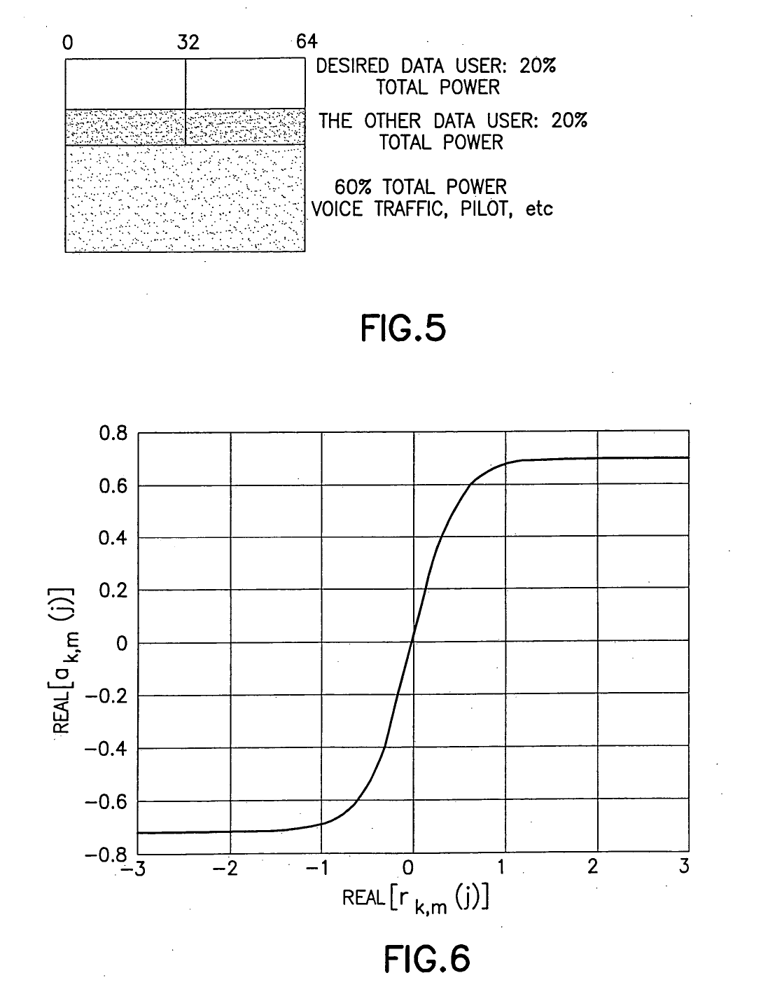

The reason that the conditional mean estimator works well can be intuitively explained by observing FIG. 6, where the real part of the symbol estimate Re(â_{k,m}(j)) is plotted as a function of the real part of the initial noisy soft estimate Re(r_{k,m}(j)). The hyperbolic function essentially acts as a clipper, which provides near-hard decision output when the initial estimate is reliable, i.e, when |Re(r_{k,m}(j))|is large. On the contrary, if the initial estimate is less reliable, the output is reduced to alleviate the possible error propagation impact.

Optimization of Detection Order and Further Iterations

In the LMMSE-SIC algorithm discussed above, the detection order is assumed to be (1, 2, . . . ,M). However, the performance of the successive detection can be improved by optimizing the detection order. The detection order for a similar V-BLAST problem can be chosen so that the worst SNR among M data streams is maximized. In particular, let ω=ω₁, . . . ,ω_{M}) denote an arbitrary ordering and let Ω be the set of all possible orderings. The cardinality of the set is |Ω|=M! and the following problem is solved to obtain the optimal ordering β:

$$β = \text{arg} {max}_{ω ∈ Ω} {{min}_{m = 1}}^{M} {γ}_{m} ( ω ) , \qquad ( 25 )$$

where γₘω) denotes the effective SNR associated with the detection of the mth transmitted data sequence for a given detection order ω. The effective SNR can be equivalently defined either at chip-level or at symbol level. The chip-level SNR for the mth data sequence is defined as a function of the error covariance matrix R_{zz}:

$${γ}_{m} ( ω ) = \frac{{σ}_{d}^{2}}{{( {R}_{zz} ( ω ) )}_{m , m}} , \qquad ( 26 )$$

which reduces to the following simple form considering the results in equations (20) and (21):
γₘ(ω)=σ_{d}²hₘ^{H}Vₘ⁻¹(ω)hₘ. (27)

Once the effective SNR is defined, equation (25) can be solved by a localized optimization procedure. In a localized optimization procedure, at each stage of the detection process, the sequence that has the best SNR is chosen for detection.

The performance of the LMMSE-SIC algorithm can be improved if more complexity is allowed and further iterations are introduced after all the data sequences are detected using the successive algorithm described above. Without loss of generality, it is assumed that in the first iteration the detection order is w=(1, 2, . . . , M) and the filter matrix W and feedback matrix B is obtained by solving the optimization equation (10). In the second iteration, however, the design of the matrix pencil W,B should be changed to reflect the fact that at the beginning of the second iteration, there has already been obtained an initial estimate of al I the transmitted data sequences. To this end, the constraint in equation (10) is changed and the optimization equation rewritten as:

$${W}^{opt} , {B}^{opt} = \text{arg} {min}_{W , B} E {‖ {B}^{H} {d}_{i} - {W}^{H} {y}_{i + F \text{:} i - F} ‖}^{2} ; \\ s . t . B = [ \begin{matrix}1 & ⋯ & {b}_{1 , M} \\ ⋮ & ⋰ & ⋮ \\ {b}_{M , 1} & ⋯ & 1\end{matrix} ] . \qquad ( 28 )$$

It is observed that in equation (28), none of the elements in the feedback matrix B is constrained to be zero. Therefore, it allows the maximum amount of decision feedback in the spatial dimension and thus improves the effective SNR for each data sequence. Note that since equation (28) can also be transformed into the form shown in equation (14) with the compact constraint representation, the solution in (20-21) applies to (28) as well. However, it is easy to see that in this case,
Z₁= . . . =Z_{M}=0, (29)
and as a result
V₁= . . . =V_{M}=V. 30)

Consequently, the solution to (28) assumes a simpler form:

$${W}_{m}^{opt} = \frac{{V}^{- 1} {h}_{m}}{{h}_{m}^{H} {V}^{- 1} {h}_{m}} \\ {( {b}_{m}^{opt} )}^{H} = {( {w}_{m}^{H} )}^{opt} {H}_{i \text{:} i} . \qquad ( 31 )$$

One further denotes as the effective γₘ^{II} for the mth data sequence in the second iteration. It is easy to show that:
γₘ^{II}=σ_{d}²hₘ^{H}V⁻¹hₘ. (32)

Note that unlike Vₘ, V is independent of the detection order.

Consequently, both wₘ, bₘ, and γₘ^{II} are independent of the detection order, meaning that all these quantities can be computed at the same time, unlike the local optimization process required in the first iteration. The detection order in the second iteration is thus obtained by simply sorting all the γₘ^{II} in descending order. Furthermore, denoting γₘ^{I} as the SNR for the mth data sequence in the first iteration, one can easily show that:
γₘ^{I}≦γₘ^{II}, (33)
for any 1≦m≦M. Note that this inequality holds regardless of the detection order used in the first and second iterations. This inequality also signifies the benefit of having a second iteration in the LMMSE-SIC algorithm, provided that the added complexity is within the confines of a practical implementation. FFT-based Complexity Reduction for a 2 Tx LMMSE-SIC Algorithm

The complexity of the MIMO LMMSE algorithm can be greatly reduced with a FFT-based approach that exploits the block Toeplitz structure of the received signal correlation matrix R, and approximates R⁻¹ with S⁻¹ where S is the associated block circulant matrix. Because the matrices to be inverted in the LMMSE-SIC algorithm, namely V_{m,m}=1, . . . ,M, are not block Toeplitz, the direct extension of the FFT-based approach to the LMMSE-SIC algorithm is not possible for a general M transmit, N receive MIMO system. For the special case where the number of transmit antennas M=2, the matrices V₁ and V₂ can be written as a rank-one or rank-two update of a block Toeplitz matrix, which allows a low-complexity inversion that is similar to the MIMO LMMSE-FFT approach. If one focuses on the first iteration of LMMSE-SIC and assumes that the detection order is ω=(1,2)

One can show that in this case:
V₁=V+σ_{d}²h₂h₂^{H}
V₂=V. (34)
and they relate to the correlation matrix R by
V₁=R−σ_{d}²h₁h₁^{H}
V₂=R−σ_{d}²H_{i:i}H_{i:i}^{H}=R−σ_{d}²h₁h₁^{H}−σ_{d}²h₂h₂^{H}. (35)

Substituting (35) into (20) and using the identity that

$$\frac{{A}^{- 1} c}{{c}^{H} {A}^{- 1} c} = \frac{{( A - {σ}_{d}^{2} {cc}^{H} )}^{- 1} c}{{{c}^{h} ( A - {σ}_{d}^{2} {cc}^{H} )}^{- 1} c} , \qquad ( 36 )$$

One can write the optimal filters as a function of correlation matrix R:

$${w}_{1} = \frac{{V}_{1}^{- 1} {h}_{1}}{{h}_{1}^{H} {V}_{1}^{- 1} {h}_{1}} = \frac{{R}^{- 1} {h}_{1}}{{h}_{1}^{H} {R}^{- 1} {h}_{1}} , \\ {w}_{2} = \frac{{V}_{2}^{- 1} {h}_{2}}{{h}_{2}^{H} {V}_{2}^{- 1} {h}_{2}} = \frac{{( R - {σ}_{d}^{2} {h}_{1} {h}_{1}^{H} )}^{- 1} {h}_{2}}{{{h}_{2}^{H} ( R - {σ}_{d}^{2} {h}_{1} {h}_{1}^{H} )}^{- 1} {h}_{2}} . \qquad ( 37 )$$

It is clear in (37) that the FFT-based approach can be used directly to get w₁ by approximating R with its associated circulant matrix S: R⁻¹≈S⁻¹. On the other hand, the application of the FFT approach to W₂ requires a little more work. Observing that R−σ_{d}²h₁h₁^{H} rank-one update of the block Toeplitz matrix R, a matrix inversion Lemma is invoked and there is obtained:

$${( R - {σ}_{d}^{2} {h}_{1} {h}_{1}^{H} )}^{- 1} = {R}^{- 1} + \frac{{σ}_{d}^{2} {R}^{- 1} {h}_{1} {h}_{1}^{H} {R}^{- 1}}{1 - {σ}_{d}^{2} {h}_{1}^{H} {R}^{- 1} {h}_{1}} \approx {S}^{- 1} + \frac{{σ}_{d}^{2} {S}^{- 1} {h}_{1} {h}_{1}^{H} {S}^{- 1}}{1 - {σ}_{d}^{2} {h}_{1}^{H} {S}^{- 1} {h}_{1}} . \qquad ( 38 )$$

Note that the approximation R⁻¹≈S⁻¹ has been used in (38). From equations (37-38), it has been shown that for a two transmit MIMO system using LMMSE-SIC algorithm, the filters wl and w₂ can be obtained using FFT-based approach to compute the inversion of the associated circulant matrix S, instead of the direct inversion of the correlation R. As a result, the complexity of the MIMO LMMSE-SIC algorithm for a two transmit system can be close to that of the MIMO LMMSE-FFT algorithm, provided that no further iterations are used in the LMMSE-SIC.

Simulation Results

The presently preferred MIMO LMMSE-SIC algorithm was evaluated in a realistic simulation chain, and the simulation parameters are tabulated in Table I.

TABLE 1
Simulation parameters.

| Parameter Name | Parameter Value |
|---|---|
| System | CDMA 1X/EVDV |
| Spreading Length | 32 |
| Channel Profile | Vehicular A |
| Mobile Speed | 50 km/h |
| Filter Length | 32 |
| Number of Tx/Rx Antennas | 2/2 |
| Modulation Format | QPSK |
| Information Data Rate | 312 kbps |
| Turbo Code Rate | 0.6771 |
| Geometry | 6 |
| Number of Walsh Codes | 3 |
| Assigned to the user | |
| Total number of Active Walsh | 25 |
| Codes in the system | |

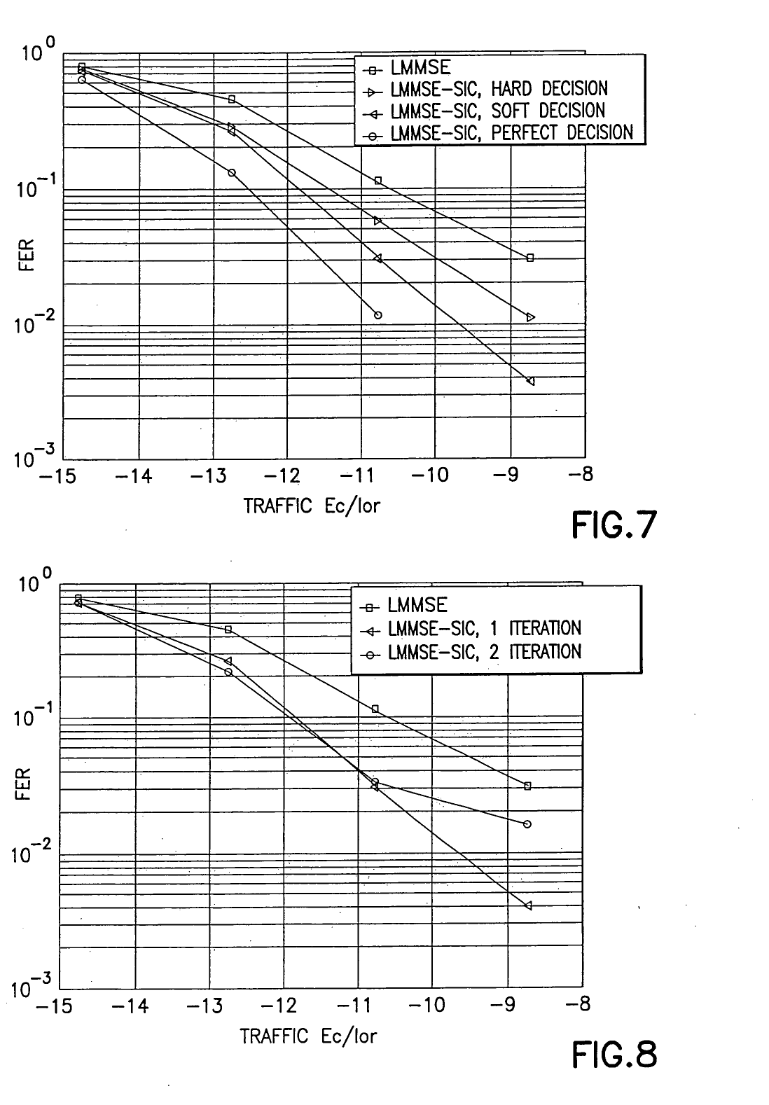

The benefit of the non-linear decision feedback is demonstrated in FIG. 7, where the MIMO LMMSE-SIC algorithm is compared with the conventional LMMSE algorithm, Note that the impact of detection order optimization is included in these results. There are three LMMSE-SIC curves shown in this figure, representing the hard-decision feedback method, the conditional mean estimator based soft decision feedback method and the ideal feedback case. It is observed that even with the hard decision feedback, the MIMO LMMSE-SIC algorithm outperforms the conventional LMMSE by about 1 dB at high SNR. Another 0.5-1 dB can be gained if the hard decisions are replaced with the soft decisions generated by the conditional mean estimator. It is significant that these gains are achieved with the assumption that the mobile receiver has only the knowledge of 3 out of 25 active Walsh codes.

In FIG. 8, the impact of further iterations in the LMMSE-SIC algorithm is investigated using the same example. Note that for both the one iteration and two iterations cases, the conditional mean estimator based soft decision feedback is used. In this case, adding a second iteration actually degrades the performance at high SNR. This detrimental effect, also known as “ping-pong” effect in the iterative detectors, is mainly attributed to the accumulation of decision errors in the iterative process. Although described in the context of particular embodiments, it will be apparent to those skilled in the art that a number of modifications and various changes to these teachings may occur. Thus, while the invention has been particularly shown and described with respect to one or more preferred embodiments thereof, it will be understood by those skilled in the art that certain modifications or changes, in form and shape, may be made therein without departing from the scope and spirit of the invention as set forth above.

1. A receiver comprising a first input for coupling to a first antenna and a second input for coupling to a second antenna for receiving at least two spread spectrum symbols from a transmitter, comprising:
a first data path for generating a first estimated symbol â₁(f) from said first input;
a second data path for generating an estimated symbol sum âₛ(f) from said first and second inputs; and
an interference cancellation module having inputs coupled to the first and second data paths, said interference cancellation module for canceling co-channel interference (CCI) between the estimated symbol sum and the first estimated symbol to generate a second estimated symbol.

2. A receiver according to claim 1, wherein said first and second data paths each comprise a separate chip equalizer.

3. A receiver according to claim 2, further comprising a channel estimator having outputs coupled to inputs of each of said separate chip equalizers.

4. A receiver according to claim 1, wherein said second data path comprises a chip equalizer for generating an estimated chip sum sequence from said first and second inputs.

5. A receiver according to claim 1, wherein the interference cancellation module operates using less than all active spreading codes in the system in which the receiver operates.

6. The receiver of claim 5, wherein the interference cancellation module operates using only spreading codes of estimated symbols that are output to a decoder.

7. The receiver of claim 1, wherein said receiver comprises a LMMSE receiver.

8. The receiver of claim 1, wherein the receiver comprises a Kalmann Filter receiver.

9. A receiver according to claim 1 wherein said second data path additionally comprises a unit for performing symbol detection of an estimated chip sum sequence to generate said estimated symbol sum âₛ(f).

10. A wireless receiver comprising a first input for coupling to a first antenna and a second input for coupling to a second antenna for receiving a transmission from a transmitter, comprising:
a channel estimator coupled to said first input and said second input, a first output, and a second output;
a first chip equalizer having a first input coupled to said at least two receive antennas and a second input of said channel estimator for suppressing inter-chip interference (ICI) and co-channel interference (CCI) from at least one input other than said first input and for generating an estimated chip sequence from said first input, said first chip equalizer having an output coupled to a first processing module for descrambling and despreading the output of said first chip equalizer and generating a first estimated symbol â₁(f);
a second chip equalizer coupled to said first and second inputs and to said second output of said channel estimator for generating an estimated chip sequence sum from said first and second inputs and a residual CCI, said second chip equalizer having an output coupled to a second processing module for descrambling and despreading the output of said second chip equalizer and generating an estimated symbol sum âₛ(f);
an interference cancellation module, having said first estimated symbol â₁(f), said estimated symbol sum âₛ(f) and an output of said second equalizer as inputs, for canceling CCI and generating at least one estimated symbol; and
a decoder for decoding said at least one estimated symbols.

11. A wireless receiver according to claim 10, further comprising a detector to detect a plurality of symbols of k users, said detected symbols being fed back to said interference cancellation module.

12. A wireless receiver according to claim 10, wherein said second chip equalizer generates a weighted sum of estimated chip sequences ds(f)=d2(f)+b2,1d1(f)+n2(f), where d1 is an estimated chip sequence from a first one of said at least two antennas, d2 is an estimated chip sequence from a second one of said at least two antennas and n2 is a noise term.

13. A method of receiving a CDMA transmission in a wireless receiver having at least two receive antennas, said transmission comprising at least two symbols from a transmitter having at least first and second transmit antennas, comprising the steps of:
generating a first estimated symbol â₁(f) from said first receive antenna;
generating an estimated symbol sum âₛ(f) from said first and second receive antennas; and
determining a second estimated symbol by canceling interference between the estimated symbol sum and the first estimated symbol.

14. A method according to claim 13, in which said step of generating an estimated symbol sum âₛ(f) comprises equalizing said input data in an equalizer having optimized filter coefficients W^{opt} and feedback weights B^{opt} that are the solution to:
$${W}^{opt} , {B}^{opt} = \text{arg} {min}_{W , B} Trace ( {R}_{zz} ) = \text{arg} {min}_{W , B} E {‖ {B}^{H} {d}_{i} - {W}^{H} {y}_{i + F \text{:} i - F} ‖}^{2} , \\ s . t . B = [ \begin{matrix}1 & & 0 \\ ⋮ & ⋰ & \\ {b}_{M , 1} & ⋯ & 1\end{matrix} ] . \qquad ( 10 )$$
where R_{zz} is an error covariance matrix, E is an error, W is a set of chip equalizers, and B is a set of feedback weights.

15. A wireless receiver comprising a first input for coupling to a first antenna and a second input for coupling to a second antenna for receiving a spread spectrum transmission comprising at least two symbols from a transmitter having at least first and second transmit antennas in which not all spreading codes are known, comprising:
means for receiving an input data on a first data path for generating a first estimated symbol â₁(f) from said first input;
means for receiving said input data on a second data path for generating an estimated symbol sum âₛ(f) from said first and second inputs;
means for utilizing said first estimated symbol â₁(f) and said estimated symbol sum âₛ(f) as a plurality of inputs to an interference cancellation module, for canceling CCI and generating at least one estimated symbol; and
means for decoding said at least one estimated symbol.

16. The wireless receiver of claim 15 wherein said first data path comprises a first chip equalizer for generating an estimated chip sequence from said first antenna.

17. The wireless receiver of claim 15, further comprising an equalizer for equalizing said input data, said equalizer having optimized filter coefficients W^{opt} and feedback weights B^{opt} that are the solution to:
$${W}^{opt} , {B}^{opt} = \text{arg} {min}_{W , B} Trace ( {R}_{zz} ) = \text{arg} {min}_{W , B} E {‖ {B}^{H} {d}_{i} - {W}^{H} {y}_{i + F \text{:} i - F} ‖}^{2} , \\ s . t . B = [ \begin{matrix}1 & & 0 \\ ⋮ & ⋰ & \\ {b}_{M , 1} & ⋯ & 1\end{matrix} ] . \qquad ( 10 )$$
where R_{zz} is an error covariance matrix, E is an error, W is a set of chip equalizers, and B is a set of feedback weights.

18. A program of machine-readable instructions, tangibly embodied on an information bearing medium and executable by a digital data processor, to perform actions directed toward receiving from multiple antennas, the actions comprising:
receiving as a first input a first estimated symbol â₁(f) derived from a first antenna;
receiving as a second input an estimated symbol sum âₛ(f) derived from said first antenna and a second antenna; and
calculating a second estimated symbol by canceling interference between the estimated symbol sum and the first estimated symbol.

19. (canceled)

20. A device comprising:
a receiver comprising a first input for coupling to a first antenna and a second input for coupling to a second antenna for receiving at least two spread spectrum symbols from a transmitter, comprising:
a first data path for generating a first estimated symbol â₁(f) from said first input and comprising;
a second data path for generating an estimated symbol sum âₛ(f) from said first and second inputs;
an interference cancellation module having inputs coupled to the first and second data paths, said interference cancellation module for canceling co-channel interference (CCI) between the estimated symbol sum and the first estimated symbol to generate a second estimated symbol; and
an equalizer for equalizing said first and second inputs, said equalizer having optimized filter coefficients W^{opt} and feedback weights B^{opt} that are the solution to:
$${W}^{opt} , {B}^{opt} = \text{arg} {min}_{W , B} Trace ( {R}_{zz} ) = \text{arg} {min}_{W , B} E {‖ {B}^{H} {d}_{i} - {W}^{H} {y}_{i + F \text{:} i - F} ‖}^{2} , \\ s . t . B = [ \begin{matrix}1 & & 0 \\ ⋮ & ⋰ & \\ {b}_{M , 1} & ⋯ & 1\end{matrix} ] . \qquad ( 10 )$$
where R_{zz} is an error covariance matrix, E is an error, W is a set of chip equalizers, and B is a set of feedback weights.

21. The device of claim 20 wherein said interference cancellation module operates using less than all active spreading codes in a system in which the receiver operates and using only spreading codes of estimated symbols that are output to a decoder.
